(19) United States
(12) Patent Application Publication
(10) Pub. No.: US 2010/0019406 A1
(43) Pub. Date: Jan. 28, 2010

(54) METHOD FOR ROTATIONAL MOULDING OF A CYLINDRICAL PRODUCT

(76) Inventor: Ole Ragnar Korsbrekke, Alesund (NO)

Correspondence Address: WENDEROTH, LIND & PONACK, L.L.P., 1030 15th Street, N.W.,, Suite 400 East, Washington, DC, 20005-1503, US

(21) Appl. No.: 12/529,969

(22) PCT Filed: Mar. 9, 2007
(86) PCT No.: PCT/NO2007/000094

§ 371 Date: Oct. 13, 2009

(51) Int. Cl. B29C 41/04; B29C 41/42

(52) U.S. Cl. 264/101

(57) ABSTRACT

A method for rotational moulding of a cylindrical product, preferably a soft PVC plastic fender, comprising a) arranging an open-end (21,22) tubular moulding tool (20) vertically; b) inserting a prefabricated lower rope attachment section (11) into the tool (20); c) dosing a PVC-paste inside the tool (20); d) inserting a prefabricated upper rope attachment section (12) including a valve into the tool (20); e) rotating the tool (20) and placing it horizontally in a moulding apparatus (6); f) setting the tool (20) in high speed rotation until the paste is uniformly distributed on the internal tubular wall; g) reducing the speed and heating the tool (20); h) cooling the tool (20) and rotating it to a vertical position and placing it in a demoulding apparatus (7), in which a gripping tool grips the upper end section (12) of the mould product (10); i) applying vacuum by means of the valve whereby part of the surface of the mould product (10) is released from the inner mould wall; and j) rotating the mould product (10) by means of the gripping tool and pulling the moulding tool (20) downwards, whereby the mould product (10) is released.

The present invention relates to a method for rotational moulding of a cylindrical product, in particular a soft PVC plastic fender.

An automated plant using the method for rotational moulding of preferably a fender, as indicated above, is also disclosed.

Today, several methods exist for creating or moulding cylindrical products of the above kind. In the moulding process, a rotating moulding tool is used, whereby the liquid PVC paste is distributed onto the inner surfaces of the moulding tool. The rotation about the moulding tool is typically carried out in one of the following modes: 1) dual rotation, i.e. rotation about two axes at a different rotational speed for each axis, and 2) rotation about the center line of the mould and tilting of the moulding tool about its center. Normally, the moulds are rotated at a rotational speed of 30-50 revolutions pr. minute, and the paste adheres to the inner walls of the mould as the temperature of the paste reaches a given value. This results in a non-uniform sheet thickness as well as an excessive material consumption.

The current moulding tools are made of aluminum having a material thickness of 4-6 mm. Aluminum moulds require extensive maintenance in order to maintain a high gloss on the moulding faces.

Cylindrical fenders made of a soft PVC plastic material are typically provided with a rope attachment in each end. The current moulding tools include a clamping mechanism for prefabricated rope attachments or a mould for rotational moulding of rope attachments integrated in the moulding tool. The latter moulding tool requires the implementation of a two-step moulding process. The casting dies have a center split in order to allow the finished product to be removed. The center split causes a visible moulding seam in the fabric of the finished product. This reduces the quality of the end product with respect to both strength and appearance. The quality of a product may e.g. be measured based on the thickness variation, i.e. uniformity, of the fabric. If the sheet thickness is not uniform, this may result, for example, in that the fender when inflated may show bulges and strength weaknesses at the thinnest parts of the fabric. Also, the fender will assume a “banana shape” if the sheet thickness is not uniform.

The Norwegian patent no. 135.405 discloses a device for taking out mould products from a rotational moulding apparatus, comprising one or more twosection moulding dies having parts being movably mounted between an open position and a closed position in the apparatus on a rotating support. The rotational moulding apparatus is provided with means for taking out the mould products from the apparatus.

U.S. Pat. No. 3,966,386 discloses a device for rotational moulding of a plastic product that is comprised, inter alia, of a two-section casting equipment as well as equipment for automatic gripping and removal of the finished product.

U.S. Pat. No. 4,531,704 describes a spray moulding device for the production of fenders, including a two-section moulding tool.

US 2005/0040563 discloses a method for manufacturing a plastic hollow body filled with foam by way of the rotation method.

GB 1.521.121 shows a method for manufacturing hollow PVC products (fenders, inter alia).

It is an object of the present invention to provide a method for rotational moulding of a cylindrical product yielding a high quality end product having a high-grade finish. That is, the product should have a uniform sheet thickness and an attractive appearance, i.e. that moulding seams should be avoided.

Another object is that the method should be cost effective, i.e. in terms of both material consumption and production costs associated with the manufacture of the product. A minimal material consumption is achieved through a uniform sheet thickness, as indicated above, and an adequate control of the material feed. The use of automated production technology by way of state-of-the-art machines and robots allows the production costs to be reduced. The production method should be automated to the greatest extent possible, minimizing the number of operators necessary for carrying out the production process.

A further object of the invention is to combine the production and use of prefabricated (spray cast) rope attachments in an efficient manner.

An even further object of the invention is that the moulding tool should require little maintenance.

The objects of the present invention are achieved by a method for rotational moulding of a cylindrical product, preferably a soft PVC plastic fender, characterized in that it comprises the steps in which:

a) an open-end tubular moulding tool is arranged in a vertical position,

b) a prefabricated lower end section, preferably a lower rope attachment (11), is inserted into and positioned inside in the lower area of the moulding tool,

c) a PVC paste is inserted and dosed inside the moulding tool (20),

d) a prefabricated upper end section, preferably an upper rope attachment (12) including a valve, is inserted into and positioned inside in the upper area of the moulding tool,

e) the moulding tool is rotated to a horizontal position and placed in a moulding apparatus,

f) the moulding tool is set in a high speed rotation until the paste has been uniformly distributed on the inside of the walls of the moulding tool between the end sections (11, 12),

g) the rotational speed is reduced and the moulding tool is heated for a time period, whereby the PVC material and the mould product (10) hardens and obtains its maximum strength,

h) the moulding tool with the mould product is cooled and rotated to a vertical position and placed in a demoulding apparatus, in which a gripping tool grips the upper end section of the mould product,

i) the mould product is placed in vacuum by means of the valve, whereby part of the surface of the mould product is released from the inner mould wall, and

j) the mould product is rotated by means of the gripping tool and the moulding tool is pulled downwards, whereby the mould product is released.

Preferred embodiments of the method are set out in claims 2 through 6.

The present invention will now be explained in more detail with reference to the attached drawings, in which:

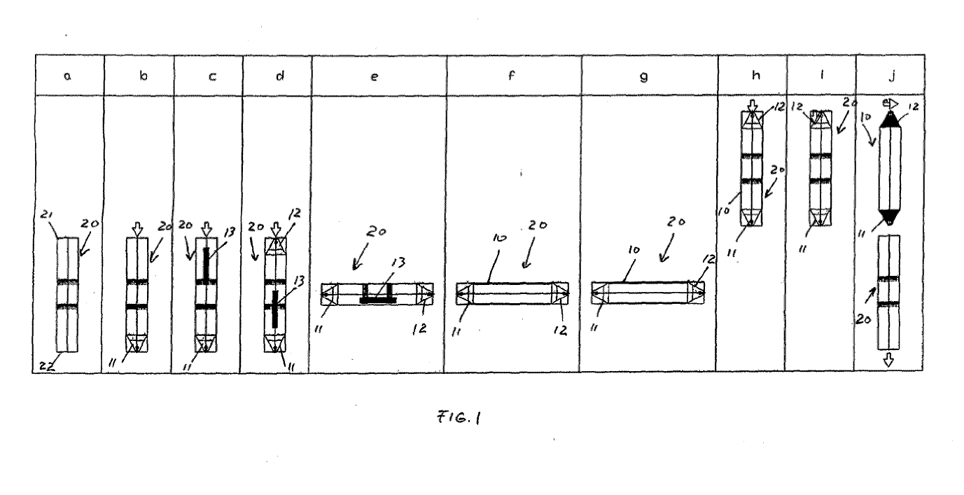

FIG. 1 is a principle drawing showing the rotational moulding of a cylindrical product according to the invention,

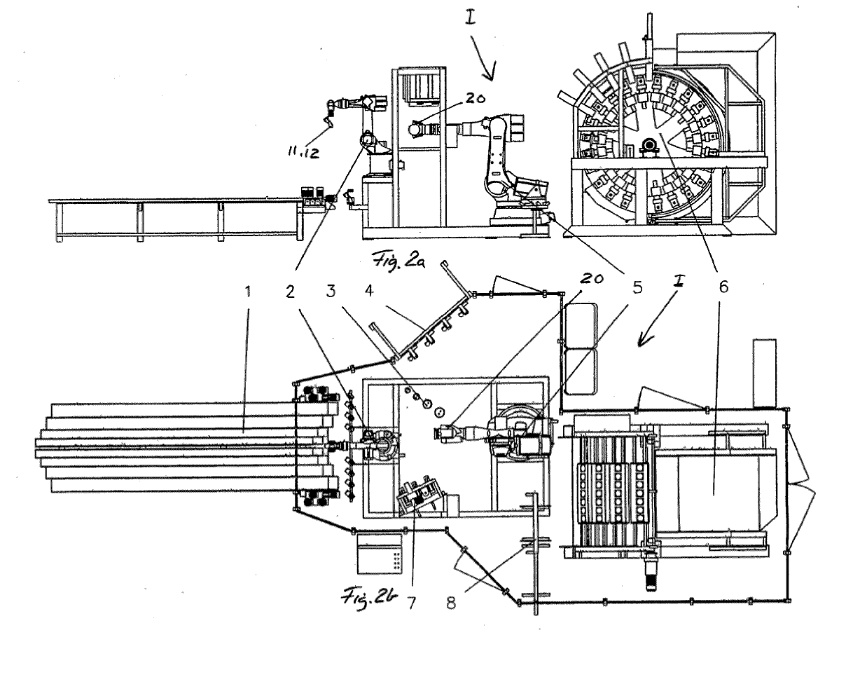

FIG. 2a shows, in a side view, an automated plant for manufacturing a cylindrical product, preferably a soft PVC plastic fender; and

FIG. 2b shows, in a top view, the automatic plant of FIG. 2a.

Referring initially to FIG. 1, the steps of the method will be explained with reference to rotational moulding of a cylindrical product, in this embodiment being a fender 10.

Step a) shows a tubular moulding tool 20 with open ends 21, 22 having been arranged in a vertical position. The moulding tool 20 is constructed of standard acid-proof steel pipes, preferably having a material thickness of 2 mm. An internal mechanical polishing and a subsequent electropolishing are performed so as to obtain a high gloss surface having a great mechanical strength. This ensures that the moulding tool requires little maintenance.

Step b) shows the moulding tool 20 in the same vertical position, with a prefabricated lower end section, preferably a lower rope attachment 11, having been inserted into and installed in the lower area of the moulding tool.

Step c) shows the moulding tool 20 with the lower rope attachment 11 in the same vertical position. PVC paste 13 has now been inserted into and dosed inside the moulding tool 20.

Step d) shows the moulding tool 20 in the same vertical position. A prefabricated upper end section, preferably an upper rope attachment 12 including a valve, has now been inserted into and installed inside in the upper area of the moulding tool.

Step e) shows the moulding tool 20 having been rotated to a horizontal position and placed in a moulding apparatus 6, which is shown in more detail in FIG. 2. In this step, the PVC paste 13 is shown inside the moulding tool 20.

Step f) shows the moulding tool 20 still within the moulding apparatus 6 and in the horizontal position, and having been set in high speed rotation to uniformly distribute the paste 13 on the inner wall surfaces of the moulding tool between end sections 11, 12.

Step g) shows the moulding tool 20 still in the horizontal position and in the moulding apparatus 6. The moulding tool 20 is now heated for a time period, whereby the PVC material and the shaped, mould product 10 hardens and obtains its maximum strength.

Step h) shows the moulding tool 20 with the mould product 10. The moulding tool 20 has been rotated to a vertical position, cooled, and placed in a demoulding apparatus 7, as shown in FIG. 2, in which a gripping tool grips the upper end section 12 of the mould product.

Step i) shows the moulding tool 20 with the mould product 10 in a vertical position, in which the mould product 10 is placed in vacuum by means of the valve, whereby part of the surface of the mould product is released from the inner wall of the mould.

Step j) shows the mould product 10 having been released from the moulding tool 20. The release of the mould product 10 is accomplished in that the gripping tool, which is gripping the upper end section 12 of the mould product, rotates the mould product 10 inside the moulding tool 20 while at the same time the moulding tool 20 is pulled downward, whereby the mould product 10 is released from the moulding tool 20.

Referring to FIG. 1 and step f), it should be mentioned that the moulding tool 20 rotates at a high rotational speed, preferably between 5 and 8 G, in the paste application process. In this manner, the centrifugal force is exploited to distribute the paste between the rope attachments, allowing the sheet thickness to be made extremely uniform (+/−0.1 mm). In the hardening process, the rotational velocity is reduced to approx. 50 revolutions pr. minute.

Referring to FIGS. 2a and 2b, the rotational moulding method according to the invention will be explained as used in connection with an automated production plant I.

Production plant I includes a storage 1 of end sections or rope attachments 11, 12. The plant further comprises a robot 2 for handling the rope attachments 11, 12. The robot 2 will select the appropriate rope attachment, i.e. the lower rope attachment 11 for positioning in the lower area of the moulding tool, or the upper rope attachment 12 including the valve for positioning in the upper area of the moulding tool. The robot 2 then feeds the selected rope attachment 11, 12 to a device 3 for inserting the selected rope attachment 11, 12. As mentioned above, the lower rope attachment 11 is first inserted into the tubular moulding tool 20. After the lower rope attachment 11 has been positioned inside in the lower area of the moulding tool, a paste dosing station 4 will apply the paste 13 to the moulding tool 20. The device 3 for inserting the upper rope attachment 12 including the valve is then activated and rope attachment 12 is inserted into and positioned inside in the upper area of the moulding tool. A robot 5 for operating the moulding tool 20 then rotates the moulding tool to a horizontal position and the moulding tool 20 with an end section 11, 12 and paste 13 is placed in the moulding apparatus 6 for moulding, hardening, and cooling of the product. The moulding tool 20 with the mould product or fender 10 is then placed in a demoulding apparatus 7, in which a gripping tool grips the upper end section 12 of the mould product. The mould product 10 is then rotated further by means of the gripping tool and the moulding tool 20 is drawn downwards, releasing the mould product 10.

A moulding tool replacement station 8 is also shown in the figure.

A number of different dimension moulding tools 20 will be available, allowing fenders of various size to be produced.

The use of the method for rotational moulding of a cylindrical product, such as a fender, for example, in connection with the above production apparatus allows for a very efficient production of a high quality fender. The production method exploits state-of-the-art production technology combining the production and use of prefabricated (spray mould) rope attachments, preferably for small fenders, in a very efficient manner.

1-6. (canceled)

7. A method for rotational moulding of a cylindrical product, preferably a fender (10) of a soft PVC plastic material,
characterized in that it comprises the steps in which:
a) an open-end (21, 22) tubular moulding tool (20) is arranged in a vertical position,
b) a prefabricated lower end section, preferably a lower rope attachment (11), is inserted into and positioned inside in the lower area of the moulding tool,
c) a PVC paste (13) is inserted and dosed inside the moulding tool (20),
d) a prefabricated upper end section, preferably an upper rope attachment (12) including a valve, is inserted into and positioned inside in the upper area of the moulding tool,
e) the moulding tool (20) is rotated to a horizontal position and placed in a moulding apparatus (6),
f) the moulding tool (20) is set in a high speed rotation until the paste has been uniformly distributed on the inside of the walls of the moulding tool between the end sections (11, 12),
g) the rotational speed is reduced and the moulding tool (20) is heated for a time period, whereby the PVC paste (13) hardens and the mould product (10) is obtained thereby,
h) the moulding tool (20) with the mould product (10) is cooled and rotated to a vertical position and placed in a demoulding apparatus (7), in which a gripping tool grips the upper end section (12) of the mould product (10),
i) the mould product (10) is placed in vacuum by means of the valve, whereby part of the surface of the mould product (10) is released from the inner mould wall, and
j) the mould product (10) is rotated by means of the gripping tool and the moulding tool (20) is pulled downwards, whereby the mould product (10) is released.

8. The method of claim 7,
characterized in that the rotational velocity in step f) is between 5 and 8 g for the paste.

9. The method of claim 7,
characterized in that the rotational velocity in step g) is approx. 50 revolutions pr. minute.

10. The method of claim 7,
characterized in that the tubular moulding tool (20) is made of acid proof steel.

11. The method of claim 7,
characterized in that the tubular moulding tool (10) is provided with a material thickness of 2 mm.

12. The method of claim 7,
characterized in that the prefabricated upper and lower end sections (12, 11) have an outer diameter which is slightly larger than the inner diameter of the moulding tool.

13. The method of claim 8,
characterized in that the rotational velocity in step g) is approx. 50 revolutions pr. minute.

14. The method of claim 8,
characterized in that the tubular moulding tool (20) is made of acid proof steel.

15. The method of claim 9,
characterized in that the tubular moulding tool (20) is made of acid proof steel.

16. The method of claim 8,
characterized in that the tubular moulding tool (10) is provided with a material thickness of 2 mm.

17. The method of claim 9,
characterized in that the tubular moulding tool (10) is provided with a material thickness of 2 mm.

18. The method of claim 10,
characterized in that the tubular moulding tool (10) is provided with a material thickness of 2 mm.

19. The method of claim 8,
characterized in that the prefabricated upper and lower end sections (12, 11) have an outer diameter which is slightly larger than the inner diameter of the moulding tool.

20. The method of claim 9,
characterized in that the prefabricated upper and lower end sections (12, 11) have an outer diameter which is slightly larger than the inner diameter of the moulding tool.

21. The method of claim 10,
characterized in that the prefabricated upper and lower end sections (12, 11) have an outer diameter which is slightly larger than the inner diameter of the moulding tool.

22. The method of claim 11,
characterized in that the prefabricated upper and lower end sections (12, 11) have an outer diameter which is slightly larger than the inner diameter of the moulding tool.

23. The method of claim 13,
characterized in that the tubular moulding tool (20) is made of acid proof steel.

24. The method of claim 13,
characterized in that the tubular moulding tool (10) is provided with a material thickness of 2 mm.

25. The method of claim 14,
characterized in that the tubular moulding tool (10) is provided with a material thickness of 2 mm.

26. The method of claim 15,
characterized in that the tubular moulding tool (10) is provided with a material thickness of 2 mm.
